(19) United States
(12) Patent Application Publication
(10) Pub. No.: US 2026/0182610 A1
(43) Pub. Date: Jul. 2, 2026

(54) AROMA COMPOSITION FOR CARBONATED BEVERAGES

(71) Applicant: SYMRISE AG, Holzminden (DE)

(72) Inventors: Daniel BALKE, Lüchtringen (DE); Jenny WEISSBRODT, Holzminden (DE); Tanja SCHUMANN, Derental (DE); Jennifer MUELLER, Brakel (DE)

(73) Assignee: SYMRISE AG, Holzminden (DE)

(21) Appl. No.: 19/126,669

(22) PCT Filed: Nov. 9, 2022
(86) PCT No.: PCT/EP2022/081242

§ 371 Date: May 2, 2025

(51) Int. Cl. A23L 27/00; A23L 2/56; A23L 2/58; A23L 2/60

(52) U.S. Cl. CPC A23L 27/88; A23L 2/56; A23L 2/58; A23L 2/60

(57) ABSTRACT

The present invention relates to an aroma powder for imparting, modifying and/or enhancing a flavour in a beverage comprising a base composition, agglomerated aroma particles and a composition partially or completely surrounding the agglomerated aroma particles, a method for producing such an aroma powder, an aroma powder obtainable or obtained by such a method, a method for imparting/modifying and/or enhancing a flavour in a beverage, preferably a carbonated beverage and the use of such an aroma composition for imparting/modifying and/or enhancing a flavour in a beverage, preferably a carbonated beverage.

The present invention relates to an aroma powder for imparting, modifying and/or enhancing a flavour in a beverage comprising a base composition, agglomerated aroma particles and a composition partially or completely surrounding the agglomerated aroma particles, a method for producing such an aroma powder, an aroma powder obtainable or obtained by such a method, a method for imparting/modifying and/or enhancing a flavour in a beverage, preferably a carbonated beverage and the use of such an aroma composition for imparting/modifying and/or enhancing a flavour in a beverage, preferably a carbonated beverage.

Carbonated beverages are produced and sold by a large number of companies covering for example refreshing beverages, energy drinks, alcoholic beverages and non-alcoholic beverages, as well as numerous different tastes.

For producing a beverage in general, either on industrial level or by consumers, typically, water is provided and flavour compositions are added.

Flavour compositions may generally be of various types, e.g. of liquid, solid or highly viscous nature, wherein the flavourings may provide various taste impressions.

Solid flavour compositions are the most advantageous type of flavour compositions, since solid flavour compositions have the lowest weight related to the provided flavour. Based on the low weight and based on the solid form, typically a powder form, such solid flavour compositions can be easily transported and stored in large amounts.

Moreover, in contrast to highly viscous flavour compositions, such as syrups, or liquid flavour compositions, solid flavour compositions are rather easy to handle, when used in methods for producing beverages. Particularly, highly viscous flavour compositions, such as syrups, may be spilled in the production process and are rather difficult to be completely removed from a production apparatus, in case some of the composition is spilled. Similarly, solid flavour compositions are preferred by consumers, since they allow clean handling.

Additionally, solid flavour compositions can be easily portioned, either in the production process or by a supplier, which can thus provide a flavour composition intended for a predetermined amount of beverage. In case of liquid flavour compositions and particularly highly viscous flavour compositions, portions of the flavour composition will always remain in the container the flavour composition is provided in. Thus, the dosage of the flavour composition in the resulting beverage is more accurate when using solid flavour compositions.

However, for producing a carbonated beverage, particular challenges need to be overcome. In case carbonated water or a carbonated beverage base is provided and shall be supplemented with solid flavour compositions, the flavour composition is added to the carbonated water or carbonated beverage base, which causes a distribution of the flavour composition over the surface of the carbonated water or carbonated beverage base. The distribution over the surface provides much contact of the flavour composition with the carbonated water or carbonated beverage base, which causes a high production of foam and/or effervescent effects. Furthermore, the flavour composition does not dissolve properly and/or causes the formation clots, which do not dissolve, sink to the bottom and remain in the produced beverage, which is thus not properly flavoured.

To overcome this deficit, the produced beverage needs to be stirred extensively. Additionally or alternatively, the clots need to be removed by expending much energy. Such measures provide additional steps in the production process, which are generally to be avoided and which require further time and energy during the production process. Furthermore, these measures cause a loss of carbonic acid in the beverage. Thus, the resulting beverage may have lost the refreshing and/or sparkling effect.

Likewise, the described disadvantages of a low dissolution and clot formation are also obtained in high frequency, when solid flavour compositions are added to non-carbonated water or beverage bases.

Thus, to overcome these disadvantages, typically a liquid or highly viscous flavour composition is provided. Such flavour compositions can be added to the water or beverage base. In a next step, the water or beverage base is mixed to dissolve and distribute the flavour composition.

Further approaches include providing non-carbonated water, adding a highly viscous flavour composition, typically a syrup, and subsequently adding carbonated acid. The addition of the carbonated acid typically provides the dissolution and distribution of the flavour composition. However, in these cases, the tools for adding carbonated acid get in contact with the water and the highly viscous flavour composition and thus need to be cleaned afterwards.

However, for the addition of solid flavour compositions to carbonated beverage, the disadvantages described above have not yet been overcome.

Thus, there is a high need to make solid flavour compositions available for flavouring carbonated water or a carbonated beverage base.

Thus, the primary object of the present invention was to provide a solid flavour composition, which overcomes some of or all of the disadvantages described above.

The primary object of the present invention is solved by an aroma powder for imparting, modifying and/or enhancing a flavour in a beverage, preferably a carbonated beverage, the aroma powder comprising
a) one, two, three or more components selected from the group consisting of sugars, sweeteners, acidity regulators, flow additives, vitamins; minerals; herbal supplements; amino acids; fatty acids; fibers; food colorants; artificial colours; turbidity agents; sugar alcohols; prebiotics; probiotics; dried fruit and vegetable concentrates or extracts; food acids, preferably selected from the group consisting of citric acid, tartaric acid, malic acid, acetic acid, lactic acid, glucuronic acid, ascorbic acid; and carbonates, preferably selected from the group consisting of sodium bicarbonate, sodium carbonate, magnesium carbonate,
b) agglomerated aroma particles,
   wherein the d50 of the agglomerated aroma particles is at least 100 μm, preferably at least 125 μm, preferably at least 150 μm, preferably at least 175 μm, preferably at least 200 μm, preferably at least 210 μm, preferably at least 220 μm,
   wherein the agglomerated aroma particles are obtained or obtainable by a method comprising the steps
   (i) producing particles comprising or consisting of one or more aromatic substance(s) and one or more carrier(s) by spray drying in a drying chamber of a spray drying apparatus,
   (ii) spraying the particles with one or more binder(s) selected from the group consisting of single or multiple sugars with reducing groups and sugar alcohols or mixtures thereof, in a fluidized bed which is integrated into the drying chamber, wherein the binder(s) is/are used in total in a concentration of 10 to 30 vol.-%, preferably 10 to 20 vol.-%, in aqueous solution,
   wherein steps (i) and (ii) take place simultaneously and the particles are permanently kept in motion and agglomerated in the drying chamber, and
   preferably wherein the aqueous solution of the binder(s) does not contain any flavourings and/or odorants,
c) a composition, partially or completely surrounding the agglomerated aroma particles, the composition comprising one, two, three or more or all components selected from the group consisting of triacetin; polyethylene glycol; vegetable oils; fruit oils, preferably citrus fruit oils, preferably citric oil; and nonpolar aromatic substances.

It was surprisingly found that an aroma powder according to the invention can be added to carbonated water or a carbonated beverage base without substantive foam formation. Furthermore, the powder sinks from the surface to the bottom and completely dissolves within short time. Thus, a good distribution of the aroma composition is already provided. Additionally, it was found that by using the aroma powder according to the invention, no loss or no significant loss of carbonic acid is obtained.

In contrast, as described above, compositions according to the state of the art produce much foam, cause an effervescent effect and a loss of carbonic acid.

An aroma composition according to the invention and a spray dried composition (comparative example) are compared in Example 2 below.

The term “aroma particles”, as used herein, describes particles containing one or more flavourings. Typically, the term “aroma particles”, as used herein, describes a granule or a powder.

The term “agglomerated aroma particles”, as used herein, describes an agglomerate, preferably a loose agglomerate, of at least two aroma particles. Preferably, the aroma particles of the agglomerated aroma particles are covered by a binder as described herein. The aroma particles of the agglomerated aroma particles are in contact with each other, either directly or through the binder. Thus, the binder usually covers the surface of the respective aroma particles completely or only partially. Typically, the agglomerated aroma particles differ from individual coated particles, which have an “onion structure” in which there is a core that is completely and uniformly covered with one of several layers of binder. Rather, the agglomerated aroma particles have a “grape structure” in which individual particles are bonded together by the binder. Typically, the term “agglomerated aroma particles” describes a porous structure and is therefore readily and rapidly dispersible or soluble in water, which is particularly advantageous for the application of the particles as described herein.

The aroma powder according to the invention comprises agglomerated aroma particles (component b)) and a composition, partially or completely surrounding the aroma particles of the agglomerated aroma particles (component c)). As described above, it is preferred that the aroma particles of the agglomerated aroma particles (component b)) are covered or partially covered with a binder. In this case, the composition (component c)) may cover the aroma particles at such sites where they are not covered by the binder, or may cover the aroma particles in addition to the binder, e.g. the aroma particles are (partially) covered by the binder in a first layer and in a further layer, the (partially) covered aroma particles are further (partially) covered with the composition (component c)), or a mixture of the options described above.

The aroma powder according to the invention is particularly advantageous for producing carbonated beverages, preferably soft drinks. Thus, it is preferred that the aroma in the agglomerated aroma particles is or comprises one, two, three or more or all flavourings selected from fruit flavours, preferably citrus fruit flavours, preferably lemon flavour; herbal flavours; blossom flavours; liquorice flavour; vanilla flavour; cinnamon flavour; and acidic flavours.

Particularly preferably, the aroma in the agglomerated aroma particles is or comprises one, two, three or more or all flavourings selected from almond flavour, apple flavour, apricot flavour, banana flavour, Bergamot flavour, birch beer flavour, blackberry flavour, Brazil nut flavour, butterscotch flavour, caramel flavour, celery flavour, chai flavour, cherry flavour, cinnamon flavour, citron flavour, clementine flavour, coconut flavour, cola flavour, coriander flavour, cranberry flavour, cucumber flavour, elderberry flavour, fig flavour, forest fruit flavour, ginger flavour, ginger ale flavour, ginseng, flavour, gooseberry flavour, grape flavour, grapefruit flavour, guarana flavour, guava flavour, hazelnut flavour, hibiscus flavour, jasmine flavour, kiwi flavour, lavender flavour, lemon flavour, lemongrass flavour, lime flavour, litchi flavour, malt flavour, mango flavour, mate flavour, melon flavour, mint flavour, mulberry flavour, nectarine flavour, orange flavour, papaya flavour, passionfruit flavour, peach flavour, pear flavour, pineapple flavour, plum flavour, pomegranate flavour, raspberry flavour, rose flavour, rosemary flavour, salak flavour, sea-buckthorn flavour, starfruit flavour, strawberry flavour, tamarind flavour, toffee flavour, vanilla flavour, Vimto flavour, and watermelon flavour.

The term “d50”, as used herein, describes the particle size distribution and represents the median size of all particles considered. Thus, a d50 of 100 μm typically means that the median size of the particles is 100 μm and that 50% of the particles of a size other than 100 μm are larger and 50% are smaller than 100 μm. Generally, it is preferred that the agglomerated aroma particles are as uniform in size as possible and that no larger agglomerates stick out.

The d50 value of agglomerated aroma particles may be measured by laser diffraction, dynamic or static light scattering, dynamic image analysis or sieve analysis.

Preferably, the term “d50 of the agglomerated aroma particles”, as used herein, includes the agglomerated aroma particles (component b)) and the composition, partially or completely surrounding the aroma particles of the agglomerated aroma particles (component c)).

Preferably, the agglomerated aroma particles have a flowability in terms of FFC value of 14 or less, preferably 12 or less. Agglomerated aroma particles with flow values of 14 or less or 12 or less, are non-cohesive and preferably have good solubility. This property is particularly advantageous for the dissolution and distribution of the aroma composition in the beverage. Preferably, the agglomerated aroma particles are in a free-flowing non-dusting form. Such particles are easy to dose, easier to process and can be used in a wide variety of applications. In this context, it is preferred that the term “agglomerated aroma particles” includes the agglomerated aroma particles (component b)) and the composition, partially or completely surrounding the aroma particles of the agglomerated aroma particles (component c)).

Preferably, the bulk density of the agglomerated aroma particles is at least 300 g/L, preferably at least 400 g/L. Further preferably, the bulk density of the agglomerated aroma particles is in the range of 200 to 600 g/L, preferably 300 to 500 g/L. A higher bulk density means that the particles have a stable core and thus a higher stability, especially with regard to abrasion. The choice of binder can influence the bulk density, since such binders improve the cohesion of the agglomerated particles and thus their stability. Advantageously, the binders used according to the invention are also those which enable bulk densities as described above. In this context, it is preferred that the term “agglomerated aroma particles” includes the agglomerated aroma particles (component b)) and the composition, partially or completely surrounding the aroma particles of the agglomerated aroma particles (component c)).

Preferably, the dust value of the agglomerated aroma particles is 13 or less, preferably 12 or less, more preferably 10 or less.

Agglomerated aroma particles with dust values of 13 or less, preferably 12 or less, represent particularly stable agglomerates which can advantageously be filled, stored and transported without causing abrasion and dust formation. The choice of binder can influence the dust formation, and it has been shown that the binders to be used in accordance with the invention meet the necessary requirements to maintain the above dust values. Furthermore, the composition partially or completely surrounding the aroma particles of the agglomerated aroma particles (component c)) further influences the dust value of the agglomerated aroma particles. In this context, it is thus preferred that the term “agglomerated aroma particles” includes the agglomerated aroma particles (component b)) and the composition, partially or completely surrounding the aroma particles of the agglomerated aroma particles (component c)).

When producing the agglomerated aroma particles, as described above, it is preferred that the particles are permanently kept in motion and agitated and/or circulated in the drying chamber. This ensures that smaller particles and dust are continuously wetted with binder and are then very likely to collide with other particles and agglomerate further. Individual particles coated with binder are not generated in the process due to the frequent collision of particles wetted with binder, but agglomerates, preferably loose agglomerates, with a porous structure are formed. Advantageously, the process according to the invention can be carried out in a spray drying chamber with an integrated fluidized bed without the need for transfer to another device. Ways of separating such particles agglomerated to the desired size, as well as effective wetting with binder and circulation of the particles are described in EP3117720A1. Preferably, the process according to the invention is carried out in a spray drying agglomeration apparatus as disclosed in EP3117720A1. A method for producing agglomerated aroma particles has been described in PCT/EP2020/083317.

The term “wherein the binder(s) is/are used in total in a concentration of 10 to 30 vol.-% in aqueous solution”, as used above, is to be understood such that the binder used in step (ii) is prepared as an aqueous solution and the amount is calculated based on the amount of the spray emulsion, which is sprayed in the spray drying step for producing particles in step (i). Preferably, the amount of dry mass of the binder is in a range of from 10 to 30 wt.-%, preferably in a range of from 10 to 20 wt.-%, based on the amount of the spray emulsion, which is sprayed in the spray drying step for producing particles in step (i). For example, for every 100 liters of the spray emulsion sprayed in step (i), 10 l of binder (i.e. 10 vol.-%) is sprayed in step (ii), or in terms of solids: for every 50 kg of solids from the spray emulsion in step (i), 1 kg of binder dry mass (i.e. 20 wt.-%) is sprayed.

The binder may be selected from single or multiple sugars with reducing groups and sugar alcohols or mixtures thereof. Single or multiple sugars with reducing groups include mono-, di-, oligo- and polysaccharides. The monosaccharides and polysaccharides to be used according to the invention contain reducing groups, i. e. free aldehyde groups with reducing properties. Preferably, the monosaccharides or polysaccharides with reducing groups or the mixtures thereof have a dextrose equivalent of at least 8, preferably at least 12, particularly preferably at least 18. A combination of vegetable gum and modified starch is a preferred binder.

The term “wherein the aqueous solution of the binder(s) does not contain any flavourings and/or odorants”, as used herein, is meant to be understood such that the aqueous solution does not contain any flavourings and/or odorants, in addition to the binder, particularly compounds to be used as binder, as described herein, in case the binder or a compound thereof may be interpreted as a flavouring and/or odorant.

In case the binder itself does not contain any flavourings and/or odorants, usually the flavourings in the aroma particles are not uniformly distributed over the agglomerate formed by the agglomerated aroma particles and are hardly present on the surface. As a result, they are effectively protected from oxidation by the binder and/or composition (component c)). This is remarkable, in case the binder and/or the composition (component c)) does not form a closed layer on the surface of the particles, but merely glues them together. Surprisingly, however, the presence of reducing groups on the surface, as described herein, is sufficient to protect the flavourings and/or odorants from oxidation.

The composition, partially or completely surrounding the aroma particles of the agglomerated aroma particles (component c)) is preferably added to the agglomerated aroma particles as a liquid or a semi-solid composition. The composition is brought in contact with the agglomerated aroma particles and the further components provided, as described herein, followed by a mixing step. The further components, as described herein, can be (partially) present as fine particles or dusts, which typically provide high production of foam under contact with water, which however shall be avoided. Advantageously, the composition then serves as a “glue”, which further agglomerates the particles with each other, and particularly binds the further components to the agglomerates. Thus, even in case the composition is added in liquid or semi-solid form, after the mixing, a powder is obtained.

Preferably, the amount of the composition, partially or completely surrounding the aroma particles of the agglomerated aroma particles (component c)) is in a range of from 0.005 to 2.5 wt.-%, preferably in a range of from 0.01 to 2 wt.-%, preferably in a range of from 0.05 to 1.5 wt.-%, preferably in a range of from 0.075 to 1 wt.-%, preferably in a range of from 0.1 to 0.5 wt.-%, based on the aroma powder.

It was surprisingly found that the composition, partially or completely surrounding the aroma particles of the agglomerated aroma particles (component c)) provides particular advantages for reducing or preventing the formation of foam when the aroma powder according to the invention is added to carbonated water or a carbonated beverage base.

It is preferred that component a) is present in solid form.

It is preferred that the d50 of the agglomerated aroma particles in a range of from 100 to 1000 μm, preferably in the range of from 125 to 900 μm, preferably in the range of from 150 to 800 μm, preferably in the range of from 175 to 750 μm, preferably in the range of from 200 to 700 μm, preferably in the range of from 210 to 675 μm, preferably in the range of from 220 to 650 μm, preferably in the range of from 250 to 600 μm, preferably in the range of from 300 to 500 μm preferably in the range of from 325 to 375 μm.

It was found that the d50 of the agglomerated particles needs to be in a particular range. If the d50 is too low, the applied aroma powder will not sink from the surface to the bottom and will thus provide a particularly increased foam production. If the d50 is too high, the applied aroma powder will sink from the surface to the bottom, but will not distribute evenly and there is a high risk of clot formation.

It is further preferred that the amount of the agglomerated aroma particles in the aroma powder is in a range of from 10 to 40 wt.-%, preferably 15 to 35 wt.-%, preferably 20 to 30 wt.-%, based on the total weight of the aroma powder, and/or that the combined amount of the agglomerated aroma particles and the composition partially or completely surrounding the aroma particles of the agglomerated aroma particles in the aroma powder is in a range of from 10 to 40 wt.-%, preferably 15 to 35 wt.-%, preferably 20 to 30 wt.-%, based on the total weight of the aroma powder.

Further, it is preferred in the aroma powder according to the invention that the agglomerated aroma particles comprise or consist of one or more flavouring(s) and one or two or all substances selected from binders, carriers, and emulsifiers, preferably wherein the agglomerated aroma particles comprise or consist of
2 to 35 wt.-%, preferably 15 to 25 wt.-% of one or more flavouring(s), based on the total weight of the agglomerated aroma particles,
65 to 98 wt.-% of one or two or all substances selected from binders, carriers, and emulsifiers, based on the total weight of the agglomerated aroma particles,
preferably 1 to 10 wt.-% binders, based on the total weight of the agglomerated aroma particles.

The term “1 to 10 wt.-% binders” as used above, is to be read in context of the 65 to 98 wt.-% of one or two or all substances selected from binders, carriers, and emulsifiers, as described above. Thus, it is preferred that the amount of one or two or all substances selected from binders, carriers, and emulsifiers is in a range of from 65 to 98 wt.-%, wherein preferably the particular amount of the binders is 1 to 10 wt.-% and in this case, 55 to 97 wt.-% (i.e. the remainder of the 65 to 98 wt.-%) are carriers, and emulsifiers, provided that the sum of binders, carriers and emulsifiers equals the 65 to 98 wt.-% described above.

Preferably, the, one or more or all binder(s) is/are selected from the group consisting of sugar alcohols, in particular mannitol, mono-, di- and oligosaccharides with reducing groups or mixtures containing or consisting of mono-, di- and/or oligosaccharides with reducing groups, in particular glucose, mannose, galactose, maltose, lactose, cellobiose, and maltodextrin, and polysaccharides with reducing groups, preferably vegetable gums, in particular gum arabic, traganth, gum ghatti, agar, carrageenan, guar flour and carubin, and mixtures thereof.

Preferably, the, one or more or all carrier(s) is/are selected from the group consisting of maltodextrins, dextrins, starches, flours and fibrous materials, and mixtures thereof.

Preferably, the, one or more or all emulsifier(s) is/are selected from the group consisting of gum arabic, modified starches, proteins, in particular vegetable proteins, native or modified pectins and soluble fractions of soy polysaccharides and mixtures thereof.

The present invention further relates to a method for producing an aroma powder, preferably an aroma powder according to the invention, the method comprising the steps.
i) providing one, two, three or more components selected from the group consisting of sugars, sweeteners, acidity regulators, flow additives, vitamins; minerals; herbal supplements; amino acids; fatty acids; fibers; food colorants; artificial colours; turbidity agents; sugar alcohols; prebiotics; probiotics; dried fruit and vegetable concentrates or extracts; food acids, preferably selected from the group consisting of citric acid, tartaric acid, malic acid, acetic acid, lactic acid, glucuronic acid, ascorbic acid; and carbonates, preferably selected from the group consisting of sodium bicarbonate, sodium carbonate, magnesium carbonate,
   and mixing the provided components until a homogeneous base mixture is obtained,
ii) providing agglomerated aroma particles, wherein the d50 of the agglomerated aroma particles in a range of from 100 to 1000 μm, preferably in the range of from 125 to 900 μm, preferably in the range of from 150 to 800 μm, preferably in the range of from 175 to 750 μm, preferably in the range of from 200 to 700 μm, preferably in the range of from 210 to 675 μm, preferably in the range of from 220 to 650 μm, preferably in the range of from 250 to 600 μm, preferably in the range of from 300 to 500 μm preferably in the range of from 325 to 375 μm,
iii) adding the agglomerated aroma particles provided in step ii) to the homogeneous base mixture obtained in step i) and mixing the composition until a homogeneous aroma mixture is obtained,
iv) providing a liquid composition comprising one or two or all compounds selected from the group consisting of triacetin; polyethylene glycol; vegetable oils; fruit oils, preferably citrus fruit oils, preferably citric oil; and nonpolar aromatic substances,
   optionally wherein the liquid composition further comprises one or more aroma substance(s).
v) injecting the liquid composition provided in step iv) to the aroma mixture obtained in step iii) and mixing the obtained composition, to provide further agglomeration of the aroma particles,
   or
providing further agglomeration of the aroma particles by spray agglomeration, preferably fluidized bed spray agglomeration, wherein the liquid composition provided in step iv) is sprayed onto the aroma mixture obtained in step iii), preferably the agglomerated aroma particles obtained in step iii), preferably wherein the spray agglomeration further includes a drying step.

What was said above with regard to the aroma powder according to the invention, applies accordingly to the method according to the invention, particularly with regard to the preferred features.

As described above, the liquid composition provided in step iv) and injected in step v) serves as a “glue”, which further agglomerates the particles with each other, and particularly binds the further components, particularly those provided in step i), which can be (partially) present as fine particles or dusts, to the agglomerates. Thus, such fine particles or dusts, which typically provide high production of foam under contact with water, can be reduced or even avoided in the obtained aroma powder.

Furthermore, it is particularly advantageous that steps iv) and v) are performed after steps i) to iii), since during mixing processes, typically fine particles or dusts are produced due to mechanical forces.

Agglomerated aroma particles in step ii) of the method according to the invention may be provided as described herein. Particularly, agglomerated aroma particles may be provided as described in PCT/EP2020/083317.

It is thus preferred that in step ii) of the method according to the invention, the agglomerated aroma particles are provided by a method comprising the steps
(ii.a) producing particles comprising or consisting of one or more aromatic substance(s) and one or more carrier(s) by spray drying in a drying chamber of a spray drying apparatus,
(ii.b) spraying the particles with one or more binder(s) selected from the group consisting of single or multiple sugars with reducing groups and sugar alcohols or mixtures thereof, in a fluidized bed which is integrated into the drying chamber, wherein the binder(s) is/are used in total in a concentration of 10 to 30 vol.-%, preferably 10 to 20 vol.-%, in aqueous solution,
   wherein steps (ii.a) and (ii.b) take place simultaneously and the particles are permanently kept in motion and agglomerated in the drying chamber, and
   preferably wherein the aqueous solution of the binder(s) does not contain any flavourings and/or odorants.

When providing the agglomerated aroma particles, as described above, it is preferred that the particles are permanently kept in motion and agitated and/or circulated in the drying chamber. This ensures that smaller particles and dust are continuously wetted with binder and are then very likely to collide with other particles and agglomerate further. Individual particles coated with binder are not generated in the process due to the frequent collision of particles wetted with binder, but agglomerates, preferably loose agglomerates, with a porous structure are formed. Advantageously, the process according to the invention can be carried out in a spray drying chamber with an integrated fluidized bed without the need for transfer to another device. Ways of separating such particles agglomerated to the desired size, as well as effective wetting with binder and circulation of the particles are described in EP3117720A1. Preferably, the process according to the invention is carried out in a spray drying agglomeration apparatus as disclosed in EP3117720A1. A method for producing agglomerated aroma particles has been described in PCT/EP2020/083317.

The term “wherein the binder(s) is/are used in total in a concentration of 10 to 30 vol.-% in aqueous solution”, as used above, is to be understood such that the binder used in step (ii) is prepared as an aqueous solution and the amount is calculated based on the amount of the spray emulsion, which is sprayed in the spray drying step for producing particles in step (i). Preferably, the amount of dry mass of the binder is in a range of from 10 to 30 wt.-%, preferably in a range of from 10 to 20 wt.-%, based on the amount of the spray emulsion, which is sprayed in the spray drying step for producing particles in step (i). For example, for every 100 liters of the spray emulsion sprayed in step (i), 10 l of binder (i.e. 10 vol.-%) is sprayed in step (ii), or in terms of solids: for every 50 kg of solids from the spray emulsion in step (i), 1 kg of binder dry mass (i.e. 20 wt.-%) is sprayed.

The binder may be selected from single or multiple sugars with reducing groups and sugar alcohols or mixtures thereof. Single or multiple sugars with reducing groups include mono-, di-, oligo- and polysaccharides. The monosaccharides and polysaccharides to be used according to the invention contain reducing groups, i.e. free aldehyde groups with reducing properties. Preferably, the monosaccharides or polysaccharides with reducing groups or the mixtures thereof have a dextrose equivalent of at least 8, preferably at least 12, particularly preferably at least 18. A combination of vegetable gum and modified starch is a preferred binder.

The term “wherein the aqueous solution of the binder(s) does not contain any flavourings and/or odorants”, as used herein, is meant to be understood such that the aqueous solution does not contain any flavourings and/or odorants, in addition to the binder, particularly compounds to be used as binder, as described herein, in case the binder or a compound thereof may be interpreted as a flavouring and/or odorant.

In case the binder itself does not contain any flavourings and/or odorants, usually the flavourings in the aroma particles are not uniformly distributed over the agglomerate formed by the agglomerated aroma particles and are hardly present on the surface. As a result, they are effectively protected from oxidation by the binder and/or composition (component c)). This is remarkable, in case the binder and/or the composition (component c)) does not form a closed layer on the surface of the particles, but merely glues them together. Surprisingly, however, the presence of reducing groups on the surface, as described herein, is sufficient to protect the flavourings and/or odorants from oxidation.

The composition provided in step iv) of the method according to the invention is preferably a liquid or a semi-solid composition. The composition is brought in contact with the agglomerated aroma particles and followed by a mixing step, as described in the next steps of the method according to the invention. The composition then serves as a “glue”, which further agglomerates the particles. Thus, even in case the composition is added in liquid or semi-solid form, after the mixing, a powder is obtained. A drying step may thus be performed, but is not mandatory.

The invention further relates to an aroma powder, preferably an aroma powder according to the invention as described above, obtainable or obtained by a method according to the invention.

What was said above with regard to the aroma powder according to the invention applies accordingly to the aroma powder according to the invention obtainable or obtained by a method according to the invention, particularly with regard to the preferred features.

As described above, it is advantageous that during the method according to the invention, the liquid composition is provided and injected. Consequently, the amounts of fine particles or dusts is reduced or may be even avoided.

It is preferred for the aroma powder according to the invention obtainable or obtained by a method according to the invention that the d50 of the agglomerated aroma particles is at least 100 μm, preferably at least 125 μm, preferably at least 150 μm, preferably at least 175 μm, preferably at least 200 μm, preferably at least 210 μm, preferably at least 220 μm.

It is further preferred for the aroma powder according to the invention obtainable or obtained by a method according to the invention that the d50 of the agglomerated aroma particles is in a range of from 100 to 1000 μm, preferably in the range of from 125 to 900 μm, preferably in the range of from 150 to 800 μm, preferably in the range of from 175 to 750 μm, preferably in the range of from 200 to 700 μm, preferably in the range of from 210 to 675 μm, preferably in the range of from 220 to 650 μm, preferably in the range of from 250 to 600 μm, preferably in the range of from 300 to 500 μm preferably in the range of from 325 to 375 μm.

Furthermore, it is preferred that the amount of the agglomerated aroma particles in the aroma powder is in a range of from 10 to 40 wt.-%, preferably 15 to 35 wt.-%, preferably 20 to 30 wt.-%, based on the total weight of the aroma powder, and/or that the combined amount of the agglomerated aroma particles and the composition partially or completely surrounding the aroma particles of the agglomerated aroma particles in the aroma powder is in a range of from 10 to 40 wt.-%, preferably 15 to 35 wt.-%, preferably 20 to 30 wt.-%, based on the total weight of the aroma powder.

The invention further relates to a method for imparting, modifying and/or enhancing a flavour in a beverage, preferably a carbonated beverage, the method comprising the steps
i) providing water, preferably carbonated water,
ii) providing an aroma powder according to the invention,
iii) adding the aroma powder provided in step ii) to the water provided in step i).

It was found that the dissolution of the aroma powder decreases when higher amounts of the aroma powder shall be dissolved in a particular amount of water, preferably carbonated water. Nevertheless, even if decreased, the dissolution was still better than for a composition of the state of the art. Similar results were obtained for the reduced/prevented foam formation.

It is thus preferred that the amount of the aroma powder added in step iii) is in a range of from 0.05 to 25 g/L, preferably 0.1 to 20 g/L, preferably 0.25 to 15 g/L, preferably 0.5 to 12.5 g/L, preferably 1 to 10 g/L, based on the water, preferably carbonated water, provided in step i).

Furthermore, the invention relates to the use of an aroma powder according to the invention for imparting, modifying and/or enhancing a flavour in a beverage, preferably a carbonated beverage.

As described, the dissolution and the foam formation are less advantageous but still superior to compositions of the state of the art, when higher amounts of the aroma powder are used.

It is thus preferred that the use comprises adding aroma powder in a range of from 0.05 to 25 g/L, preferably 0.1 to 20 g/L, preferably 0.25 to 15 g/L, preferably 0.5 to 12.5 g/L, preferably 1 to 10 g/L, based on the water, preferably carbonated water, to the water, preferably carbonated water.

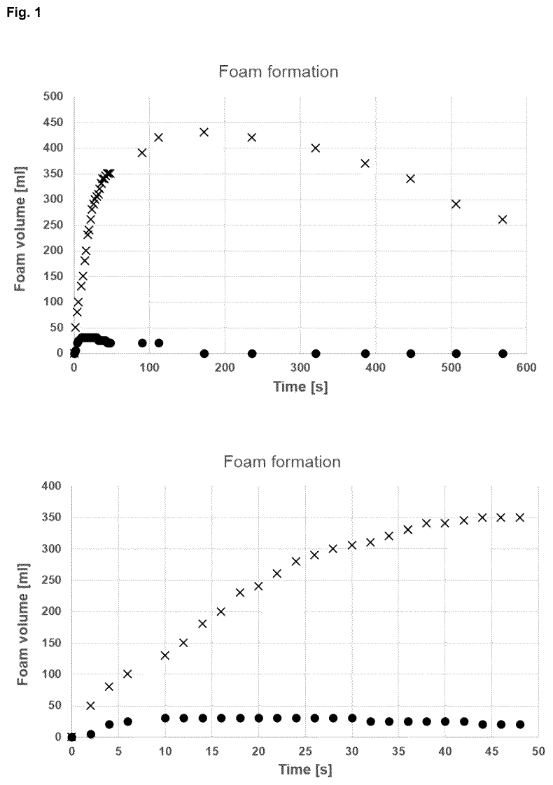

FIG. 1 depicts the plotted results of an analysis of the foam formation according to Example 2, comparing an aroma powder according to the invention (comprising agglomerated aroma particles with d50=450 μm; filled dots) with a comparative aroma powder (comprising a spray dried aroma with d50=50 μm; comparative example; crosses), showing the results over a time of 10 minutes (upper graph) or, respectively, the first 50 seconds (lower graph).

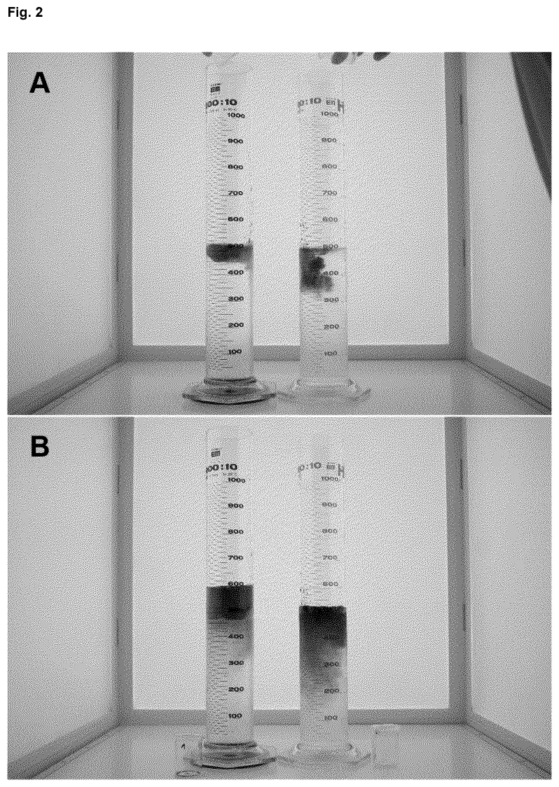

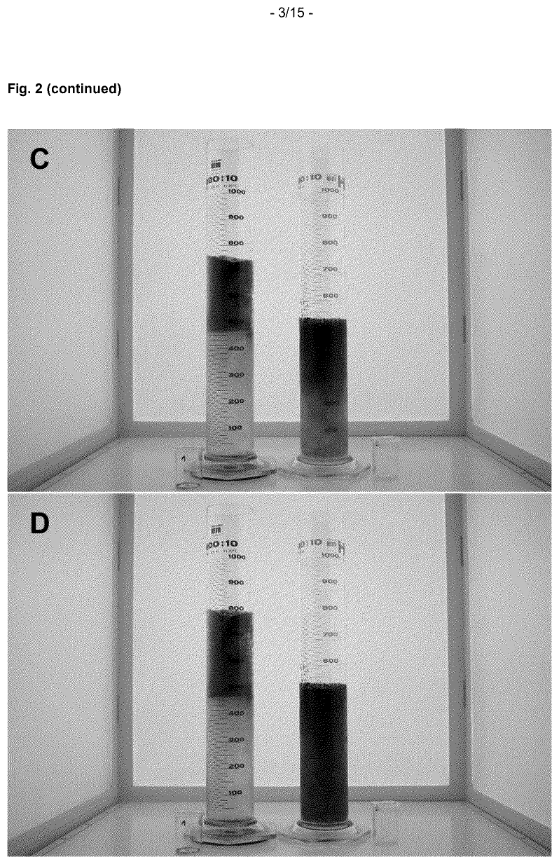

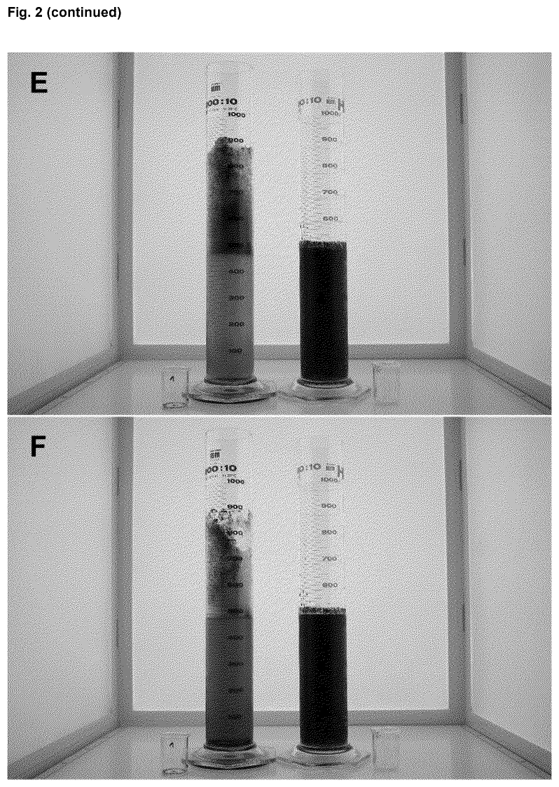

FIG. 2 is a visualisation of the analysis of the foam formation according to Example 2, comparing an aroma powder according to the invention (comprising agglomerated aroma particles with d50=450 μm; right cylinder) with a comparative aroma powder (comprising a spray dried aroma with d50=50 μm; comparative example; left cylinder), with the results at the time of adding the powders (A), after 10 seconds (B), after 26 seconds (C), after 36 seconds (D), after 112 seconds (E) and after 568 seconds (F).

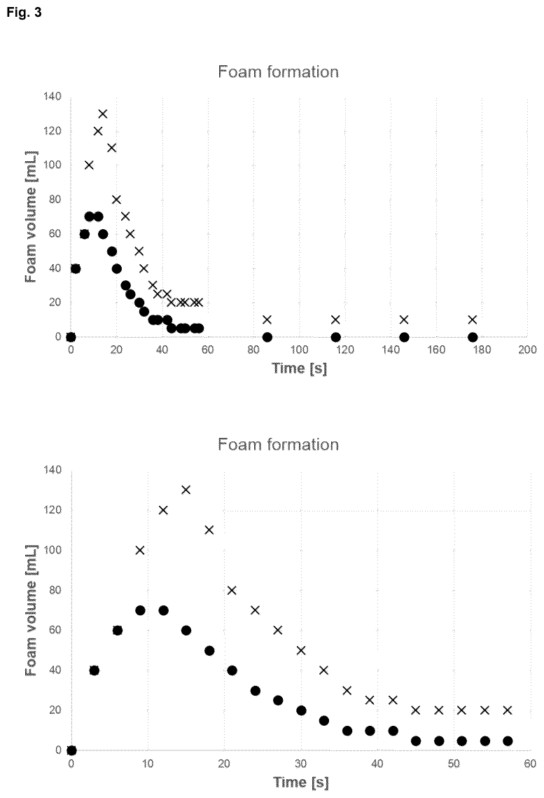

FIG. 3 depicts the plotted results of an analysis of the foam formation according to Example 3, comparing an aroma powder according to the invention (comprising agglomerated aroma particles with d50=272.5 μm; filled dots) with a commercial aroma powder (with d50=199.5 μm; comparative example; crosses), showing the results over a time of 3 minutes (upper graph) or, respectively, the first 1 minute (lower graph).

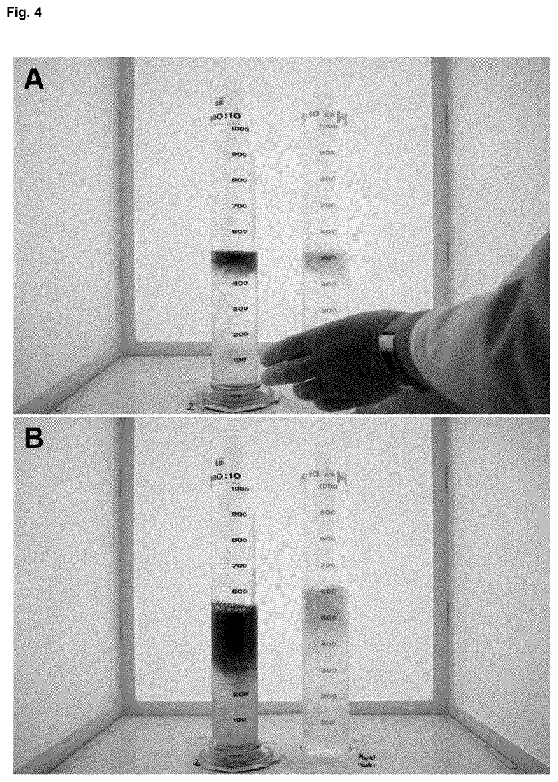

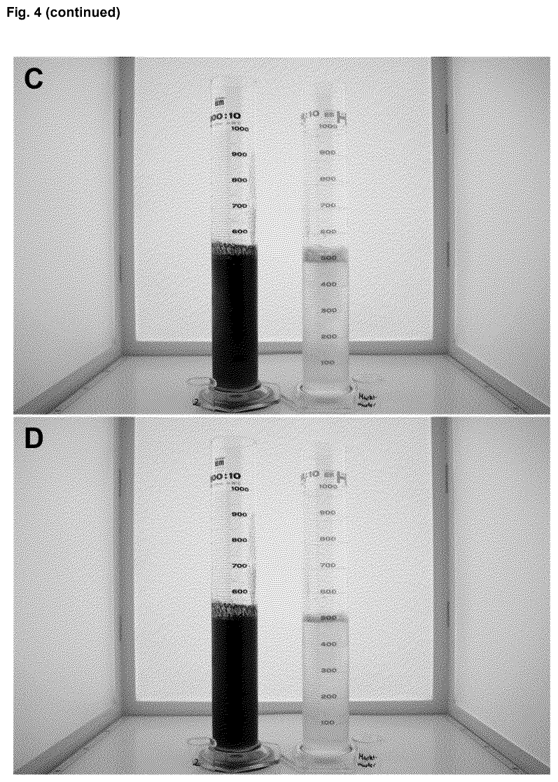

FIG. 4 is a visualisation of the analysis of the foam formation according to Example 3, comparing an aroma powder according to the invention (comprising agglomerated aroma particles with d50=272.5 μm; left cylinder) with a commercial aroma powder (with d50=199.5 μm; comparative example; right cylinder), with the results 2 seconds after adding the powders (A), after 14 seconds (B), after 26 seconds (C) and after 38 seconds (D).

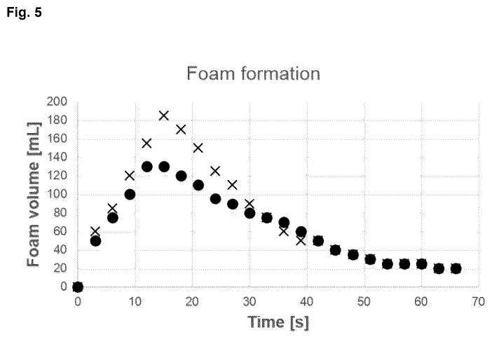

FIG. 5 depicts the plotted results of an analysis of the foam formation according to Example 4, comparing an aroma powder according to the invention (comprising agglomerated aroma particles with d50=240.8 μm; crosses) with an aroma powder according to the invention (comprising agglomerated aroma particles with d50=272.5 μm; filled dots), showing the results over a time of approximately 1 min.

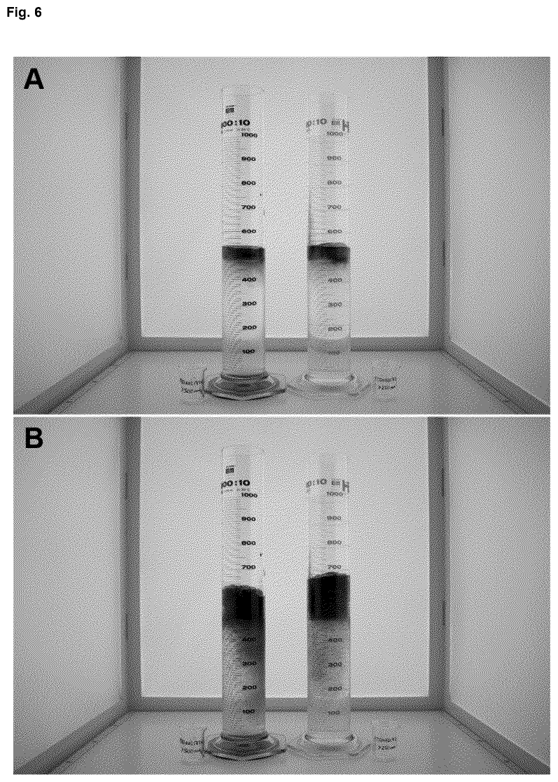

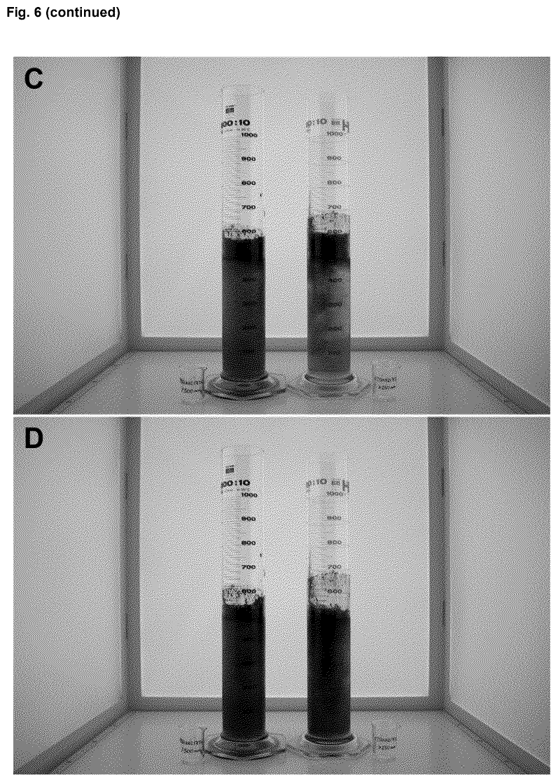

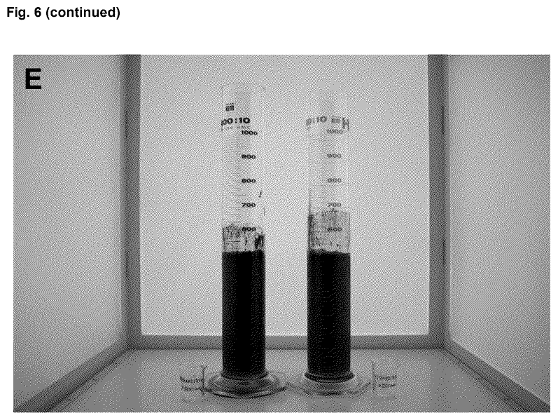

FIG. 6 is a visualisation of the analysis of the foam formation according to Example 4, comparing an aroma powder according to the invention (comprising agglomerated aroma particles with d50=240.8 μm; right cylinder) with an aroma powder according to the invention (comprising agglomerated aroma particles with d50=272.5 μm; left cylinder), with the results 3 seconds after adding the powders (A), after 15 seconds (B), after 27 seconds (C), after 39 seconds (D), and after 60 seconds (E).

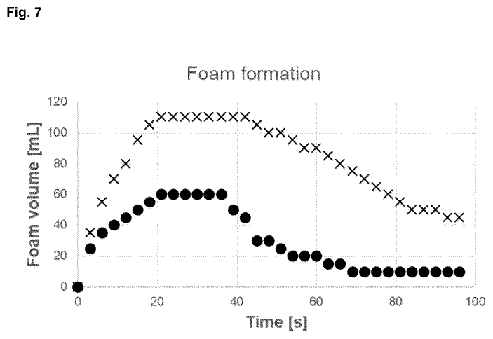

FIG. 7 depicts the plotted results of an analysis of the foam formation according to Example 5, comparing an aroma powder according to the invention (comprising 0.1 wt.-% of the composition; crosses) with an aroma powder according to the invention (comprising 0.3 wt.-% of the composition; filled dots), showing the results over a time of 1.5 minutes.

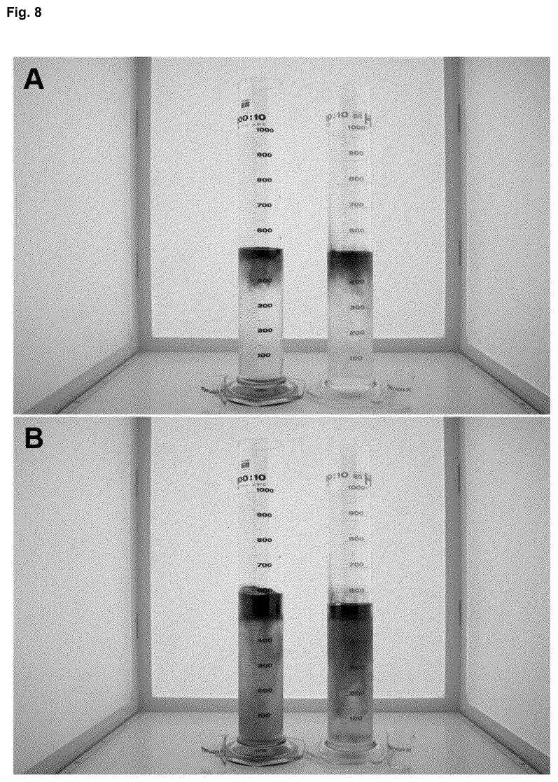

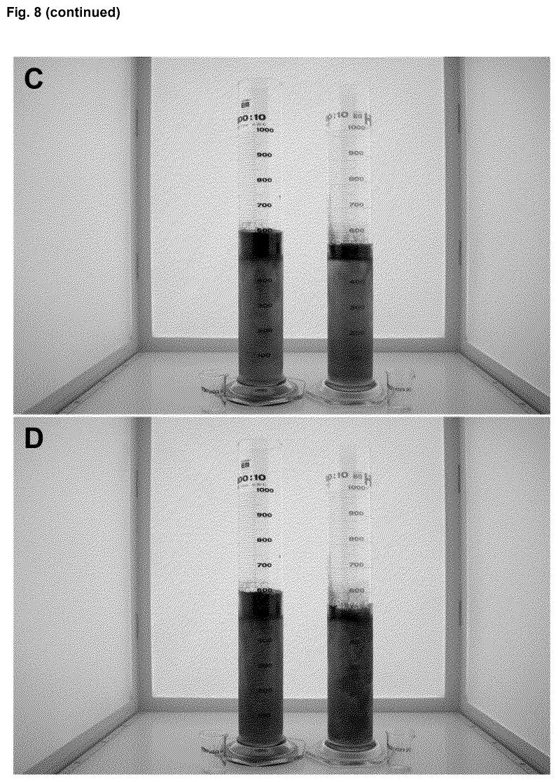

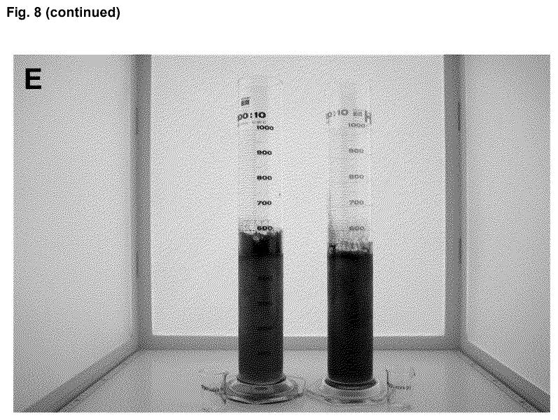

FIG. 8 is a visualisation of the analysis of the foam formation according to Example 5, comparing an aroma powder according to the invention (comprising 0.1 wt.-% of the composition; left cylinder) with an aroma powder according to the invention (comprising 0.3 wt.-% of the composition; right cylinder), with the results 3 seconds after adding the powders (A), after 18 seconds (B), after 33 seconds (C), after 48 seconds (D), and after 63 seconds (E).

Further aspects and advantages of the invention result from the subsequent description of preferred examples.

### EXAMPLES

### Example 1: Production of an Aroma Powder

The following compounds were provided to produce composition 1 (comparative example) and composition 2 (according to the invention).

| Compounds - List A | Composition 1 | | Composition 1 | |
|---|---|---|---|---|
| Saccharose | 1.7 | g | 1.7 | g |
| Citric acid | 0.9 | g | 0.9 | g |
| Sweetener mixture | 0.4 | g | 0.4 | g |
| Trisodium citrate dihydrate | 0.1 | g | 0.1 | g |
| Caffeine | 0.08 | g | 0.08 | g |
| Silicondioxide | 0.01 | g | 0.01 | g |
| Total amount | 3.19 | g | 3.19 | g |

| Compounds - List B | Composition 1 | Composition 2 |
|---|---|---|
| Spray dried cola flavour | 1.01 g | — |
| (d50 = 50 μm) | | |
| Agglomerated aroma particles | — | 1.01 g |
| produced according to | | |
| PCT/EP2020/083317; cola flavour | | |
| (d50 = 450 μm) | | |

The compounds of List A were provided as powders and were mixed. The mixing was performed for 2 min in the chopper until a homogenous mixture was obtained.

The compounds of List B were added to the homogenous mixture obtained above and the obtained compositions were mixed carefully for 1 minute. In case of composition 1, the powder was collected to obtain an aroma powder (aroma powder 1).

Only in case of composition 2, 0.01 g triacetin comprising fruit peel oil were provided as liquid composition, which was slowly injected to the mixture obtained above. After mixing for 2 minutes, a powder was obtained (aroma powder 2).

### Example 2: Analysis of Foam Formation and Dissolution

Two glass cylinders with identical dimensions were provided and filled with 500 ml carbonated water each.

4.2 g of aroma powder 1, as produced in Example 1, was added to the first glass cylinder and simultaneously, 4.2 g of aroma powder 2, as produced in Example 1, was added to the second glass cylinder. After the addition, it was not interacted with the glass cylinders, i.e. the mixtures were not stirred or otherwise affected.

Pictures of both glass cylinders were taken for 10 min and the amount of produced foam was determined based on the volume units on the glass cylinders.

Foam volume

| Time [s] | Aroma powder 1 [mL] | Aroma powder 2 [mL] |
|---|---|---|
| 0 | 0 | 0 |
| 2 | 50 | 5 |
| 4 | 80 | 20 |
| 6 | 100 | 25 |
| 10 | 130 | 30 |
| 12 | 150 | 30 |
| 14 | 180 | 30 |
| 16 | 200 | 30 |
| 18 | 230 | 30 |
| 20 | 240 | 30 |
| 22 | 260 | 30 |
| 24 | 280 | 30 |
| 26 | 290 | 30 |
| 28 | 300 | 30 |
| 30 | 305 | 30 |
| 32 | 310 | 25 |
| 34 | 320 | 25 |
| 36 | 330 | 25 |
| 36 | 330 | 25 |
| 38 | 340 | 25 |
| 40 | 340 | 25 |
| 42 | 345 | 25 |
| 44 | 350 | 20 |
| 46 | 350 | 20 |
| 48 | 350 | 20 |
| 90 | 390 | 20 |
| 112 | 420 | 20 |
| 172 | 430 | 0 |
| 236 | 420 | 0 |
| 320 | 400 | 0 |
| 386 | 370 | 0 |
| 446 | 340 | 0 |
| 506 | 290 | 0 |
| 568 | 260 | 0 |

The results of the analysis of the foam formation is plotted in FIGS. 1 and 2.

It was clearly demonstrated that the foam formation was significantly reduced in composition 2 (according to the present invention), compared to composition 1 (comparative example).

Likewise, even without stirring the mixtures, composition 2 was sinking and thereby completely and uniformly dissolving over the whole volume of the carbonated water. After less than 2 minutes, a uniform mixture was obtained. No clot formation was observed.

In contrast, even after approximately 10 minutes, no uniform mixture was obtained by composition 1. Furthermore, clot formation was observed, wherein the clots remained at the bottom of the glass cylinder.

### Example 3: Analysis of Foam Formation and Dissolution

Two glass cylinders with identical dimensions were provided and filled with 500 ml carbonated water each.

4.2 g of an aroma powder according to the invention and with a cola flavour was added to the first glass cylinder (aroma powder 3). Simultaneously, 4.2 g of a commercial aroma powder with a lemon flavour was added to the second glass cylinder (aroma powder 4). The d50 of aroma powder 3 was 272.5 μm. The d50 of aroma powder 4 was 199.5 μm. The commercial aroma powder does not contain the composition, partially or completely surrounding the aroma particles.

After the addition, it was not interacted with the glass cylinders, i.e. the mixtures were not stirred or otherwise affected.

Pictures of both glass cylinders were taken for 3 min and the amount of produced foam was determined based on the volume units on the glass cylinders.

Foam volume

| Time [s] | Aroma powder 3 [mL] | Aroma powder 4 [mL] |
|---|---|---|
| 0 | 0 | 0 |
| 3 | 40 | 40 |
| 6 | 60 | 60 |
| 9 | 70 | 100 |
| 12 | 70 | 120 |
| 15 | 60 | 130 |
| 18 | 50 | 110 |
| 21 | 40 | 80 |
| 24 | 30 | 70 |
| 27 | 25 | 60 |
| 30 | 20 | 50 |
| 33 | 15 | 40 |
| 36 | 10 | 30 |
| 39 | 10 | 25 |
| 42 | 10 | 25 |
| 45 | 5 | 20 |
| 48 | 5 | 20 |
| 51 | 5 | 20 |
| 54 | 5 | 20 |
| 57 | 5 | 20 |
| 86 | 0 | 10 |
| 116 | 0 | 10 |
| 146 | 0 | 10 |
| 176 | 0 | 10 |

The results of the analysis of the foam formation is plotted in FIGS. 3 and 4.

It was clearly demonstrated that the foam formation was significantly reduced in composition 3 (according to the present invention), compared to composition 4 (comparative example).

Likewise, even without stirring the mixtures, composition 3 was sinking and thereby completely and uniformly dissolving over the whole volume of the carbonated water. After less than 1 minute, a uniform mixture was obtained. No clot formation was observed.

In contrast, even after approximately 3 minutes, no uniform mixture was obtained by composition 4.

### Example 4: Analysis of Different Sizes

Two glass cylinders with identical dimensions were provided and filled with 500 ml carbonated water each.

Two aroma powders according to the invention were provided, wherein the two aroma powders had different d50 values. The different d50 values were obtained by sieving the powders with different mesh sizes.

In aroma powder 5, the d50 value was 240.8 μm. In aroma powder 6, the d50 value was 272.5 μm.

4.2 g of aroma powder 5 or 6 were simultaneously added to the first or, respectively, second glass cylinder. After the addition, it was not interacted with the glass cylinders, i.e. the mixtures were not stirred or otherwise affected.

Pictures of both glass cylinders were taken for approximately 1 min and the amount of produced foam was determined based on the volume units on the glass cylinders.

Foam volume

| Time [s] | Aroma powder 5 [mL] | Aroma powder 6 [mL] |
|---|---|---|
| 0 | 0 | 0 |
| 3 | 60 | 50 |
| 6 | 85 | 75 |
| 9 | 120 | 100 |
| 12 | 155 | 130 |
| 15 | 185 | 130 |
| 18 | 170 | 120 |
| 21 | 150 | 110 |
| 24 | 125 | 95 |
| 27 | 110 | 90 |
| 30 | 90 | 80 |
| 33 | 75 | 75 |
| 36 | 60 | 70 |
| 39 | 50 | 60 |
| 42 | 50 | 50 |
| 45 | 40 | 40 |
| 48 | 35 | 35 |
| 51 | 30 | 30 |
| 54 | 25 | 25 |
| 57 | 25 | 25 |
| 60 | 25 | 25 |
| 63 | 20 | 20 |
| 66 | 20 | 20 |

The results of the analysis of the foam formation is plotted in FIGS. 5 and 6.

It was observed that a higher d50 value provided less foam production.

### Example 5: Effect of the Composition Surrounding the Aroma Particles

Two glass cylinders with identical dimensions were provided and filled with 500 ml carbonated water each.

Two aroma powders according to the invention were provided, wherein the two aroma powders had different amounts of the composition surrounding the aroma particles.

In aroma powder 7, the composition amounted to 0.1 wt.-%, based on the total weight of the aroma powder. In aroma powder 8, the composition amounted to 0.3 wt.-%, based on the total weight of the aroma powder.

4.2 g of aroma powder 7 or 8 were simultaneously added to the first or, respectively, second glass cylinder. After the addition, it was not interacted with the glass cylinders, i.e. the mixtures were not stirred or otherwise affected.

Pictures of both glass cylinders were taken for 1.5 min and the amount of produced foam was determined based on the volume units on the glass cylinders.

Foam volume

| Time [s] | Aroma powder 7 [mL] | Aroma powder 8 [mL] |
|---|---|---|
| 0 | 0 | 0 |
| 3 | 35 | 25 |
| 6 | 55 | 35 |
| 9 | 70 | 40 |
| 12 | 80 | 45 |
| 15 | 95 | 50 |
| 18 | 105 | 55 |
| 21 | 110 | 60 |
| 24 | 110 | 60 |
| 27 | 110 | 60 |
| 30 | 110 | 60 |
| 33 | 110 | 60 |
| 36 | 110 | 60 |
| 39 | 110 | 50 |
| 42 | 110 | 45 |
| 45 | 105 | 30 |
| 48 | 100 | 30 |
| 51 | 100 | 25 |
| 54 | 95 | 20 |
| 57 | 90 | 20 |
| 60 | 90 | 20 |
| 63 | 85 | 15 |
| 66 | 80 | 15 |
| 69 | 75 | 10 |
| 72 | 70 | 10 |
| 75 | 65 | 10 |
| 78 | 60 | 10 |
| 81 | 55 | 10 |
| 84 | 50 | 10 |
| 87 | 50 | 10 |
| 90 | 50 | 10 |
| 93 | 45 | 10 |
| 96 | 45 | 10 |

The results of the analysis of the foam formation is plotted in FIGS. 7 and 8. It was observed that a higher amount of the composition provided less foam production. It was further observed that the aroma powder with the higher amount of the composition was sinking faster to the bottom and provided a faster dissolution.

1-14. (canceled)

15. An aroma powder for imparting, modifying, and/or enhancing a flavor in a beverage, the aroma powder comprising:
(a) one or more components selected from sugars, sweeteners, acidity regulators, flow additives, vitamins, minerals, herbal supplements, amino acids, fatty acids, fibers, food colorants, artificial colors, turbidity agents, sugar alcohols, prebiotics, probiotics, dried fruit and vegetable concentrates or extracts, food acids, and carbonates;
(b) agglomerated aroma particles having a d50 of at least 100 μm, the agglomerated aroma particles obtained or obtainable by a method comprising:
(i) spray drying an emulsion comprising one or more aromatic substances and one or more carriers in a drying chamber of a spray drying apparatus to produce particles; and
(ii) simultaneously spraying the particles with one or more binders selected from mono- or polysaccharides with reducing groups and sugar alcohols, in a fluidized bed integrated into the drying chamber;
wherein the one or more binders are present in an amount of 10 to 30 vol. % based on the emulsion of (b)(i), and
(b)(i) and (b)(ii) occur simultaneously with the particles continuously kept in motion and agglomerated within the drying chamber; and
(c) a composition at least partially coating the agglomerated aroma particles, the composition comprising one or more of triacetin, polyethylene glycol, vegetable oils, fruit oils, and nonpolar aromatic substances.

16. The aroma powder of claim 15 comprising 10 to 40 wt. % of the agglomerated aroma particles, based on a total weight of the aroma powder.

17. The aroma powder of claim 15 comprising 10 to 40 wt. % of a combination of the agglomerated aroma particles and the composition at least partially coating the agglomerated aroma particles, based on a total weight of the aroma powder.

18. The aroma powder of claim 15, wherein the d50 of the agglomerated aroma particles is 100 to 1000 μm.

19. The aroma powder of claim 15, wherein the agglomerated aroma particles comprise one or more flavourings and one or more binders, carriers, and/or emulsifiers.

20. The aroma powder of claim 19, wherein the agglomerated aroma particles comprise:
2 to 35 wt. % of one or more flavourings, based on a total weight of the agglomerated aroma particles, and
65 to 98 wt. % of one or more of binders, carriers, and/or emulsifiers, based on the total weight of the agglomerated aroma particles.

21. The aroma powder of claim 19, wherein:
the one or more binders are selected from sugar alcohols and mono-, di- and oligosaccharides with reducing groups,
the one or more carriers are selected from maltodextrins, dextrins, starches, flours, and fibrous materials, and
the one or more emulsifiers are selected from gum arabic, modified starches, proteins, native or modified pectins, and soluble fractions of soy polysaccharides.

22. A method for producing the aroma powder of claim 15 comprising:
(i) forming a homogenous base mixture by mixing one or more components selected from sugars, sweeteners, acidity regulators, flow additives, vitamins, minerals, herbal supplements, amino acids, fatty acids, fibers, food colorants, artificial colours, turbidity agents, sugar alcohols, prebiotics, probiotics, dried fruit and vegetable concentrates or extracts, food acids, and carbonates;
(ii) providing agglomerated aroma particles having a d50 of 100 to 1000 μm;
(iii) adding the agglomerated aroma particles of (ii) to the homogeneous base mixture of (i) and mixing to obtain a homogeneous aroma mixture;
(iv) providing a liquid composition comprising one or more of triacetin, polyethylene glycol, vegetable oils, fruit oils, and nonpolar aromatic substances; and
(v) injecting the liquid composition of (iv) into the homogeneous aroma mixture of (iii) and mixing the combination to provide further agglomeration of the aroma particles, or providing further agglomeration of the aroma particles by spray agglomeration, wherein the liquid composition of (iv) is sprayed onto the aroma mixture of (iii).

23. The method of claim 22, wherein the agglomerated aroma particles of (ii) are provided by a method comprising:
(ii.a) producing particles comprising one or more aromatic substances and one or more carriers by spray drying in a drying chamber of a spray drying apparatus; and
(ii.b) spraying the particles with one or more binders selected from single or multiple sugars with reducing groups and sugar alcohols in a fluidized bed which is integrated into the drying chamber, wherein the binders are in a concentration of 10 to 30 vol. % in aqueous solution,
wherein (ii.a) and (ii.b) take place simultaneously and the particles are continuously kept in motion and agglomerated in the drying chamber.

24. An aroma powder obtainable or obtained by the method of claim 22, wherein the agglomerated aroma particles have a d50 of at least 100 μm.

25. The aroma powder of claim 24, wherein the d50 is 100 to 1000 μm.

26. The aroma powder of claim 24 comprising 10 to 40 wt. % of the agglomerated aroma particles, based on a total weight of the aroma powder.

27. The aroma powder of claim 24 comprising 10 to 40 wt. % of a combination of the agglomerated aroma particles and the composition at least partially coating the agglomerated aroma particles, based on a total weight of the aroma powder.

28. A method for imparting, modifying, and/or enhancing a flavor in a beverage comprising adding the aroma powder of claim 15 to the beverage.

29. The method of claim 28, wherein the aroma powder is added in an amount of 0.05 to 25 g/L based on water.

30. The method of claim 28, wherein the water is carbonated water.
